(19) United States
(12) Patent Application Publication
(10) Pub. No.: US 2008/0290989 A1
(43) Pub. Date: Nov. 27, 2008

(54) Method of controlling access to a sports facility

(75) Inventor: Andre Kudelski, Cheseaux (CH)

Correspondence Address: DAVIS BUJOLD & Daniels, P.L.L.C., 112 PLEASANT STREET, CONCORD, NH, 03301, US

(73) Assignee: SkiData AG, Grodig/Salzburg (AT)

(21) Appl. No.: 12/124,530

(22) Filed: May 21, 2008

(30) Foreign Application Priority Data
May 22, 2007 (EP) 07010101.9

(51) Int. Cl. G05B 19/00

(52) U.S. Cl. 340/5.7

(57) ABSTRACT

Controlling access to a sports facility with a user-carried non-transferable data storage medium which stores access privilege data and is read by a reading mechanism upon entry to the sports facility. A data storage medium, located on the user's sports equipment near the ground, stores control data, which is read by an antenna located near the ground at the entrance to the sports facility. The access privilege data, read from the non-transferable data storage medium upon entry, is combined by program logic with the control data read by the near-ground data storage medium on entry and then memorized. Upon each subsequent entry, the access privilege data from the non-transferable data storage medium and the control data from the near-ground data storage medium are re-read by the antenna. If there is a mismatch of the memorized combined data, entrance to the sports facility is prohibited.

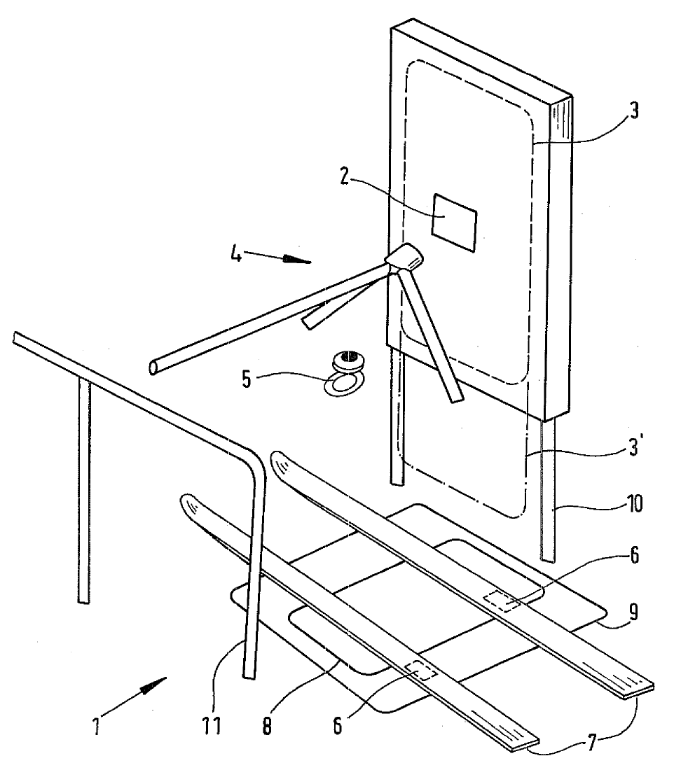

This application claims priority from EP Application Serial No. 07010101.9 filed May 22, 2007.

### FIELD OF THE INVENTION

The invention relates to a method of controlling access to a sports facility, especially a winter sports facility such as a ski-lift, using a nontransferable data storage medium.

### BACKGROUND OF THE INVENTION

In addition to transferable cards for single rides or point credit cards entitling several individuals to one or several rides on a ski-lift or a similar personal transport system, it is frequent in winter sports regions to issue non-transferable cards or the like data media; the use of which is restricted to a single individual each. Most of these cards have an extended validity such as several days or one complete season. Most non-transferable cards or data storage media are sold for prices greatly reduced from those for short-term use; thus the risk exists of their being misused by being passed around among several persons.

In order to avert this risk, a photograph of the rightful holder may be affixed to the data storage medium. Preparing such data storage medium—also referred to as “ski pass”—entails considerable expense especially of timer which may result in long lines and waits at the box office.

In addition, personnel must be stationed at the facility's point of access to visually check the user seeking entry to the winter sports facility against the photograph on the data medium. Such visual check is often considered excessive and is felt to be unpleasant. For this reason, the checks are performed on a random sampling basis only and thus are not comprehensive.

To ensure that such visual monitoring by personnel at the point of access is not noticeable to the user, it has been known to digitize the photograph, to store it in a data base and to display it on a monitor screen adjacent the access point. Here, too, the check is limited to samples—apart from the fact that the time needed to prepare the photograph at the box office is still prohibitive.

Further, it has been known to set up at a facility's point of access a digital camera which takes an initial photograph upon the user's first entry of the facility. The initial photograph is stored in a data base together with access privilege data on the non-transferable data storage medium as read out by reading means at the point of access is and then compared with another photograph taken by a digital camera as the holder attempts to gain subsequent access to the facility (EP 1,647,918 A1). This obviates the preparation of the data storage medium at the box office, but not a visual examination of pictures.

AT 601 U1 teaches to store the access privilege data of a skiing facility on non-contacting data storage media affixed to a ski and to provide an antenna on the ground within the facility's entrance space to check the access privilege data stored on these data storage media.

FR 2,778,978 A1 teaches to place a non-contacting data storage medium on a ski so as to prevent ski theft. DE 1,001,969 C2 discloses a rental system for winter sports equipment in which the user carries a data storage medium storing access privilege data and the rented skis carry a data storage medium storing the same access privilege data, with the two data storage media being read and access being denied if the data sets read out do not match.

### SUMMARY OF THE INVENTION

It is the object of the invention to provide a method which effectively and in a simple manner prevents the abusive passing around of nontransferable data storage media intended to obtain access to a sports facility.

The non-transferable data storage medium carried along by the user may be a ticket carrying a bar code, a magnetic strip or an electronic chip. The chip may be of the contacting variety or a chip with an antenna, i.e. a non-contacting data storage medium, especially a transponder. For example, the non-contacting data storage medium may be disposed in a wristwatch or a piece of clothing such as a glove worn by the user. If the data storage medium is of the non-contacting kind, the reading means includes an antenna and preferably a coil-type antenna designed to safely detect the data storage medium the user is carrying at a height somewhere between the knee and head levels. Only one person is entitled to carry the non-transferable data storage medium on him/her. To this end, the non-transferable data storage medium may store as access privilege data—in addition to the period of validity or the like—the name of, or other data specific to, the authorized person.

The additional data storage medium to be used in accordance with the invention is provided on a piece of equipment the user is carrying near the ground for exercising his/her sport, i.e. at a height below the knees, especially at the height of his/her feet or lower.

To this end, and assuming a use of winter sports equipment, the additional data storage medium may be provided in one or both skis, in a snowboard, on one or both ski boots or snowboard boots or in a sole thereof, in a component of the binding such as the toe or heel clamp or the binder plate, in the ski brake or e.g. in one or both ski sticks or the like, but also in a sledge, sleigh or another item of sports equipment.

The further data storage medium to be used near the ground may be a non-contacting data storage medium such as a transponder to be read out by means of an antenna disposed near the ground and preferably designed to form a coil. The companion antenna may be embedded in the ground or the floor at the entrance to the ski lift or the like sports facility; likewise, it may be placed on the ground by being incorporated in a mat having a sliding surface for skis, e.g. one composed of bristles.

It is not necessary for the antenna to be placed directly on the ground. Instead, it may be disposed in the lower portion of the bar assembly laterally bounding the entrance area. If the nontransferable data storage medium too is of the non-contacting variety, i.e. if it can be read by means of a reader using an antenna, that antenna may be connected in the ground area to the same reader as the antenna used for the non-transferable data storage medium. It is equally possible to provide a second reading means connected to the antenna placed in the ground area.

If the nontransferable data storage medium is of the non-contacting variety, the reading means used for reading out the access privilege data from that medium may include an antenna extending to the ground area so as to equally form the antenna used for reading out the near-ground data storage medium.

The control data of the further near-ground non-contacting data storage medium may comprise data specific to each item of sports equipment, such as the manufacturer and the serial number of the piece of sports equipment, or data specific to the non-contacting data storage medium, e.g. a serial number of the electronic chip incorporated in the data storage medium.

As the user enters the sports facility, the access privilege data read out by the reading means from the non-transferable data storage medium are combined with the control data read out upon entry from the near-ground data storage medium by a computer employing program logic and then memorized in the computer or a data base, for example, connected to the reading means. The data combined by program logic preferably comprise use-specific data such as the name of the user of the non-transferable data storage medium together with data specific to the sports equipment or the near-ground data storage medium.

As the user enters the facility a subsequent time, the access privilege data on the non-transferable data storage medium read out by the reading means and the control data read out by the near-ground antenna from the near-ground data storage medium are compared with the combined data memorized in the data base, with access being denied in case of mismatch.

In order to provide for comprehensive monitoring, the access privilege data on the non-transferable data medium and the control data on the near-ground data storage medium are preferably combined and memorized upon the users' first entry of the sports facility. In addition, the access privilege data on the non-transferable data storage medium and the control data on the near-ground data storage medium are read out during future entries of each users and compared with the combined data memorized during the first entry.

The access structure includes various forms of person individualizing means. For example, the entrance may be blocked by mechanical blocking means such as a turnstile, but also by acoustic or optical signaling means such as a device similar to traffic lights. Such acoustic or optical signaling means may be set up at the entrance or at a personnel-monitored terminal device.

The invention is intended especially for winter sports facilities comprising a plurality of ski-lifts and the like person transport installations. The first and each subsequent access will then constitute the first access to one or a subsequent access to the same or another personal transport installation of the winter sports facility.

The sports equipment is generally fitted to each individual user. For example, the length of a pair of skis generally is dependent on the user's body height and the ski binding is fitted to the user's shoe size, etc. For this reason, the invention prevents the sports equipment from being passed on by the privileged user to an unauthorized person so that the likelihood of the non-transferable data storage medium being misused is next to nil. In addition, the inventive method does not require additional processing time and lends itself to full automation. Also, the cost of the data storage medium incorporated in the sports equipment is presently negligible.

### BRIEF DESCRIPTION OF THE DRAWINGS

Below, an embodiment of the invention will be explained in greater detail with reference to the attached drawing, the only FIGURE of which shows the access or entrance area of a winter sports facility.

### DETAILED DESCRIPTION OF THE INVENTION

As shown in the drawing, entrance 1 to a facility such as a ski-lift has set up thereat a reader 2 including an antenna (shown in phantom) arranged in front of a turnstile 4. As a user attempts to obtain access, reader 2 is used to read out access privilege data from a non-transferable data storage medium 5 disposed e.g. in a wristwatch the user is wearing.

Another non-contacting data storage medium 6 is provided in sports equipment 7, namely the user's skis, disposed near the ground. Such other data storage medium 6 stores control data such as a serial number of the electronic chip embedded in data storage medium 6.

Data storage medium 6 embedded in the near-ground sports equipment such as skis 7 is read out by means of an antenna placed e.g. in a mat 9 laid on the ground at entrance 1 in front of turnstile 4. Antenna 8 may be connected to reader 2.

If the non-transferable data storage medium 5 stores valid access privilege data, turnstile 4 is released for first-time entry. At the same time on first-time entry, a computer using program logic combines the access privilege data read out by reader 2 from non-transferable data storage medium 5 with the control data read out via antenna 8 from data storage medium 6 and then memorizes the combined data in means such as a data base. The program logic is suited to combine data such as user specific data—e.g. the user's name—with the serial number of the chip embedded in data storage medium 6.

Upon each subsequent access, the access privilege data on the non-transferable data storage medium 5 is read out using antenna 3 and the control data on the near-ground data storage medium 6 is read out using antenna 8, and these data are compared by the computer to the combined data memorized for the first entry. If the access privilege data are valid and the data memorized and combined with the data read from data storage media 5 and 6 on subsequent entry match those combined and memorized during first entry, turnstile 4 opens the entrance 1 while it blocks entrance 1 if they do not.

As shown in the drawing in phantom at 3′, the antenna used for reading non-transferable data storage medium 5 may extend down to the ground and thus at the same time form the antenna for reading near-ground data storage medium 6. Further, the antenna for reading near-ground data storage medium 6 may be disposed e.g. in the area of frame 10 or bar assembly 11 which laterally bounds entrance 1.

1-5. (canceled)

6. A method of controlling access to a sports facility comprising a user-carried non-transferable data storage medium (5), with access privilege data being read out from the non-transferable data storage medium (5) by reading means (2) located at an entrance (1) to the sports facility as entry, at least one additional data storage medium (6) is disposed near the ground on sport equipment of the user which stores control data to be read upon entry by an antenna (3′, 8) mounted in an area of the ground near the entrance (1) to the sports facility, with the access privilege data, read on entry, from the non-transferable data storage medium (5) being compared by program logic with the control data, read on entry, from near-ground data storage medium (6) and then memorized, and with the access privilege data and the control data being read using the antennas (3′, 8) on subsequent entry from non-transferable data storage medium (5) and from near-ground data storage medium (6), respectively, causing entrance (1) to the sports facility to be blocked in case of mismatch with the memorized combined data.

7. The method as in claim 6, further comprising the step of, as the user enters the sports facility for the first time, combining the access privilege data, on the non-transferable data storage medium (5), and the control data, on the near-ground data storage medium (6), with one another and memorizing the combined access privilege data and the control data.

8. The method as in claim 7, further comprising the step of reading the access privilege data, on the non-transferable data storage medium (5), and the control data, on the near-ground data storage medium (6), during each of the user's subsequent entries and testing to determine if the access privilege data and the control data match the combined access privilege data and the control data memorized upon first entry.

9. The method as in claim 6, further comprising the step of dedication the control data, on the near-ground data storage medium (6), to be specific to one of the sports equipment and the data storage medium.

10. The method as in claim 6, further comprising the step of using a non-contacting data storage medium as the non-transferable data storage medium (5) and using an antenna (3′) which, at the same time, forms an antenna for reading the near-ground data storage medium (6) as the reading means for reading the access privilege data from the non-transferable data storage medium (5).

11. A method of controlling access to a sports facility, the method comprising the steps of:
storing access privilege data on a user-carried non-transferable data storage medium (5);
reading the access privilege data from the data storage medium (5) with a reading device (2), which is located at an entrance (1) to the sports facility, upon initial entry of the user to the sports facility;
reading control data, with an antenna (3′, 8) which is located at the entrance (1) to the sports facility near the ground, from at least one additional data storage medium (6) located on sports equipment of the user upon the initial entry of the user to the sports facility;
storing the access privilege data read by the reading device (2) and the control data read by the antenna (3′, 8);
re-reading the access privilege data from the non-transferable data storage medium (5) with the reading device (2), which is located at the entrance (1) to the sports facility, upon a subsequent entry of the user to the sports facility;
re-reading the control data from the at least one additional data storage medium (6), which is located near the ground on the user's sporting equipment, with the antenna (3′, 8), which is located at the entrance (1) to the sports facility, upon a subsequent entry of the user to the sports facility;
comparing the stored access privilege data and the stored control data with the re-read access privilege data and the re-read control data; and
preventing access to the sports facility through the entrance (1), if the re-read access privilege data and the re-read control data do not match the stored access privilege data and the stored control data, but permitting access to the sports facility, through the entrance (1), if the re-read access privilege data and the re-read control data matches the stored access privilege data and the stored control data.
